(19) United States
(12) Patent Application Publication
(10) Pub. No.: US 2005/0060421 A1
(43) Pub. Date: Mar. 17, 2005

(54) System and method for providing immersive visualization at low bandwidth rates

(76) Inventors: Chowdhary V. Musunuri, San Jose, CA (US); Raghavan Anand, San Francisco, CA (US); Johan Pirot, Fremont, CA (US); Rahul P. Kale, Milpitas, CA (US)

Correspondence Address: KATTEN MUCHIN ZAVIS ROSENMAN, 525 WEST MONROE STREET, CHICAGO, IL, 60661-3693, US

(21) Appl. No.: 10/891,078

(22) Filed: Jul. 15, 2004

Related U.S. Application Data
(60) Provisional application No. 60/487,231, filed on Jul. 16, 2003.

(51) Int. Cl. G06F 15/16

(52) U.S. Cl. 709/231

(57) ABSTRACT

A system and method are disclosed for providing immersive visualization at low bandwidth rates. The system retrieves a frame of multimedia information for transmission over a network and converts the frame from a first color space to a second color space. The system slices the frame into a plurality of frame slices and transforms each of the plurality of frame slices into a plurality of corresponding frequency domain components. The system quantizes the frequency domain components of each frame slice, when the frame slice to be processed is an intra-slice or a refresh slice, to generate quantized frequency domain components of each frame slice. The system variable-length encodes the quantized frequency domain components of each frame slice to generate compressed multimedia information associated with each frame slice. The system constructs network packets of the compressed multimedia information associated with each frame slice, and transmits the network packets via the network.

This application claims priority under 35 U.S.C. § 119(e) to U.S. Provisional Application No. 60/487,231, filed on Jul. 16, 2003, the entire content of which is hereby incorporated herein by reference.

### BACKGROUND

1. Field of the Invention

The present invention relates to multimedia information communication systems. More particularly, the present invention relates to a system and method for compressing, transmitting and receiving multimedia information, including high-resolution video, audio and data, over an information transmission network.

2. Background Information

Immersive visualization theaters provide environments for detailed inspection of intricate images, often in three dimensions and often in true “immersive” settings. Image content can be from various fields of scientific and industrial endeavor, such as from the earth sciences, the manufacturing industry (e.g., automobile, aircraft, earthmoving vehicles), the medical industry, military and government applications, and the like. Immersive visualization theaters can be multi-million dollar installations with sophisticated projection systems, high-end graphics servers and large, multi-terabyte data sets to be inspected. These data sets can contain critical information requiring inspection by a group of experts that are geographically distributed. Consequently, there is a need for a collaborative solution. A multimedia collaboration system is described in, for example, U.S. Pat. No. 5,617,539.

The transmission networks supporting immersive visualization theaters can be SONET/SDH based with rates from, for example, OC-3 and higher. High bandwidth data transmission using rates below OC-48 requires sophisticated compression techniques. Existing compression techniques, such as, for example, JPEG and MPEG, are inadequate, because the rapid computations required for these techniques are not realizable with existing hardware.

Conventional motion-estimation-based compression algorithms, such as, for example, MPEG-2 and MPEG-4, rely on complex computations to find the best prediction for each frame so that more frames can be sent at a particular bitrate at higher quality. However, as the required frame rates increase and as the frame resolution increases, it becomes difficult to perform the complex computations in real-time. Consequently, many conventional compression products are limited to rates such as, for example, 720×480 at 30 frames per second (fps). Such products are typically targeted towards DVD and HDTV applications and are, therefore, unable to process stereo video at rates of, for example, 1280×1024 or 1600×1200 at 96 fps or 120 fps. A stereoscopic video telecommunication system is described in, for example, U.S. Pat. No. 5,677,728. The left and right frames at any time in stereo video have data content similarities that can be exploited by compression algorithms. State-of-the-art stereo video compression can use disparity based coding. Such disparity based coding algorithms are highly computational intensive and are not realizable using existing hardware for high resolution, high frame rate images.

Video can be variable bitrate (VBR) in nature, since different frames can have different content and hence can be compressed to different degrees. This variation in bitrates can present several design approaches and tradeoffs for a particular application. In conventional video streaming applications over IP, the VBR stream can be converted to a constant bitrate (CBR) stream by buffering the data after encoding, and similarly buffering up to a few seconds of video before decoding at the receiver. Buffering allows for the smoothing of out-of-bitrate variations to meet the CBR requirements of the network. However, the buffering can introduce many seconds of latency for the application. With more buffering capability prior to transmission, there is more flexibility in terms of adapting the VBR to a CBR bitstream, but with the penalty of increased delay. For applications such as immersive visualization over SONET, the buffer sizes required for buffering many seconds of video can be large. Moreover, immersive visualization applications require low latency.

An immersive visualization system should be robust to errors in the bitstream introduced by the transmission network. Transmission errors can cause the video to be decoded incorrectly. Conventional compression algorithms encode P-frames (Predicted frames) based on references to the content in I-frames (Intra-frames). If each frame is coded as an I-frame, it is easier to recover from any transmission errors by synchronization to the next I-frame. Transmission errors occurring in a P-frame would cause the receiver to loose synchronization with the transmitter. Synchronization between the transmitter and the receiver can be regained to the next I-frame. In addition, any bit errors introduced in an I-frame would also require synchronization to the next I-frame. In conventional compression algorithms, the compression factor achieved is dependent on the number of P-frames introduced between I-frames. If more I-frames are inserted periodically, then the time delay required for resynchronization can be reduced at the expense of lower compression factors.

The metric that is most commonly used for measuring decoded image quality is the Peak Signal-to-Noise Ratio (PSNR), which is expressed in dB. The PSNR is measured from the pixel-to-pixel errors between the original and decoded images, on a frame-by-frame basis. Though a particular PSNR number might translate to different visual qualities for different images, beyond a certain point for most classes of images, the quality becomes visually acceptable. For the applications discussed herein, a PSNR of 45 dB or more would be considered good quality, and that of 55-60 dB would be more or less visually lossless. Such image quality can be achievable at compression ratios that range from approximately 2:1 up to approximately 10:1 or 12:1, based on, for example, the image content, bandwidth availability and acceptable frame rate. Typically, chrominance sub-sampling in the horizontal and vertical directions can also be used to achieve compression, since the human visual system is less sensitive to chrominance than luminance. For natural images, chrominance sub-sampling can work well, but for images generated by computers, such as the ones produced by an immersive visualization system, chrominance sub-sampling may not work well.

Some commercial systems can deploy target immersive visualization applications, but use very high bitrates to transmit the data, either uncompressed or using lossless compression that does not compress more than, for example, approximately 2:1 or 3:1. Other commercial systems are unable to compress full frames at high resolution at the frame rates that immersive visualization systems require, due to hardware limitations. Alternatively, other commercial systems can use temporal compression algorithms that use frame differencing methods to find redundant parts of successive images and minimize the transmission of such parts to achieve high video compression. However, due to noise introduced by interfacing electronics, such as analog-to-digital converters, such algorithms fail to effectively detect redundant portions of successive images and do not achieve optimal compression.

### SUMMARY OF THE INVENTION

A system and method are disclosed for providing immersive visualization at low bandwidth rates. In accordance with exemplary embodiments, according to a first aspect of the present invention, a system for transmitting multimedia information via a network includes means for retrieving a frame of multimedia information for transmission over the network. The system includes means for converting the frame from a first color space to a second color space. Each component of the second color space can be formed as a weighted combination of components of the first color space. The system includes means for slicing the frame into a plurality of frame slices, and means for transforming each of the plurality of frame slices into a plurality of corresponding frequency domain components. The system includes means for quantizing the frequency domain components of each frame slice when it is determined that each frame slice is to be processed as one of an intra-slice and a refresh slice to generate quantized frequency domain components of each frame slice. The system includes means for variable-length encoding the quantized frequency domain components of each frame slice to generate compressed multimedia information associated with each frame slice. The system also includes means for constructing network packets of the compressed multimedia information associated with each frame slice, and means for transmitting the network packets via the network.

According to the first aspect, the means for retrieving can include means for discarding a retrieved frame based on at least one of a size of a frame buffer for storing the retrieved frame and a rate at which frames are transmitted. The system can include means for discarding porches surrounding an active portion of the frame. The first color space can comprise a red, green, blue (RGB) color space, and the second color space comprises a luminance and chrominance (YUV) color space. The system can include means for sub-sampling chrominance of the frame in a horizontal direction. Each of the plurality of frame slices can be transformed into the plurality of corresponding frequency domain components using a discrete cosine transform. The system can include means for subtracting the frequency domain components of each frame slice from frequency domain components of a corresponding frame slice associated with a previous frame to generate a frame difference. The system can include means for comparing the generated frame difference against predetermined noise filter threshold parameters to determine whether noise is associated with each frame slice. The system can include means for canceling a noise contribution from the frame difference, to determine whether the frame slice is substantially identical to the corresponding frame slice associated with the previous frame.

According to the first aspect, the system can include means for determining whether each frame slice is to be (i) discarded or (ii) transmitted as the intra-slice or the refresh slice. The means for determining can comprise means for characterizing a feature within the frame as static when (i) the feature within the frame is substantially identical to a feature associated with a previous frame or (ii) movement of the feature within the frame is below a predetermined threshold. The system can include means for detecting a change in status of the feature within the frame from static to moving. The system can include means for assigning all frame slices of the frame as refresh slices when the change in status is detected. The means for quantizing can comprise means for modifying an amount of quantization based on available bandwidth for transmitting. According to an exemplary embodiment of the first aspect, the network packets can comprise Ethernet packets. The means for transmitting can comprise means for receiving network statistic information associated with transmission of the network packets, and means for modifying a transmission rate of the network packets based on the received network statistic information.

According to a second aspect of the present invention, a system for receiving multimedia information transmitted via a network includes means for extracting compressed multimedia information from network packets received via the network. The system includes means for inverse variable length coding the extracted compressed multimedia information to generate quantized frequency domain components of frame slices of a frame of multimedia information. The system includes means for inverse quantizing the quantized frequency domain components of the frame slices to generate frequency domain components of the frame slices. The system includes means for inverse transforming the frequency domain components of the frames slices to generate a plurality of frame slices. The system includes means for combining the plurality of frame slices to form the frame of multimedia information. The system includes means for converting the frame from a first color space to a second color space. Each component of the second color space is formed as a weighted combination of components of the first color space. The system includes means for displaying the converted frame.

According to the second aspect, the means for combining can comprise means for replacing missing frame slices of the plurality of frame slices using corresponding frame slices from a previous frame. Frequency domain components of the frame slices can be inverse transformed into the plurality of frame slices using an inverse discrete cosine transform. The first color space can comprise a luminance and chrominance (YUV) color space, and the second color space can comprise a red, green, blue (RGB) color space. The system can include means for adding porches surrounding an active portion of the frame.

According to a third aspect of the present invention, a method of transmitting multimedia information via a network includes the steps of: a.) retrieving a frame of multimedia information for transmission over the network; b.) converting the frame from a first color space to a second color space, wherein each component of the second color space is formed as a weighted combination of components of the first color space; c.) slicing the frame into a plurality of frame slices; d.) transforming each of the plurality of frame slices into a plurality of corresponding frequency domain components; e.) quantizing the frequency domain components of each frame slice when it is determined that each frame slice is to be processed as one of an intra-slice and a refresh slice to generate quantized frequency domain components of each frame slice; f.) variable-length encoding the quantized frequency domain components of each frame slice to generate compressed multimedia information associated with each frame slice; g.) constructing network packets of the compressed multimedia information associated with each frame slice; and h.) transmitting the network packets via the network.

According to the third aspect, the step of retrieving can comprise the step of: i.) discarding a retrieved frame based on at least one of a size of a frame buffer for storing the retrieved frame and a rate at which frames are transmitted. The method can comprise the step of: j.) discarding porches surrounding an active portion of the frame. The first color space can comprise a red, green, blue (RGB) color space, and the second color space comprises a luminance and chrominance (YUV) color space. The method can comprise the step of: k.) sub-sampling chrominance of the frame in a horizontal direction. Each of the plurality of frame slices can be transformed into the plurality of corresponding frequency domain components using a discrete cosine transform. The method can comprise the steps of: l.) subtracting the frequency domain components of each frame slice from frequency domain components of a corresponding frame slice associated with a previous frame to generate a frame difference; m.) comparing the generated frame difference against predetermined noise filter threshold parameters to determine whether noise is associated with each frame slice; and n.) canceling a noise contribution from the frame difference, to determine whether the frame slice is substantially identical to the corresponding frame slice associated with the previous frame.

According to the third aspect, the method can comprise the step of: o.) determining whether each frame slice is to be (1) discarded or (2) transmitted as either the intra-slice or the refresh slice. The step of determining can comprise the steps of: p.) characterizing a feature within the frame as static when (1) the feature within the frame is substantially identical to a feature associated with a previous frame and (2) movement of the feature within the frame is below a predetermined threshold; q.) detecting a change in status of the feature within the frame from static to moving; and r.) assigning all frame slices of the frame as refresh slices when the change in status is detected. The step of quantizing can comprise the step of: s.) modifying an amount of quantization based on available bandwidth for transmitting. According to an exemplary embodiment of the third aspect, the network packets can comprise Ethernet packets. The step of transmitting can comprise the steps of: t.) receiving network statistic information associated with transmission of the network packets; and u.) modifying a transmission rate of the network packets based on the received network statistic information.

According to a fourth aspect of the present invention, a method of receiving multimedia information transmitted via a network includes the steps of: a.) extracting compressed multimedia information from network packets received via the network; b.) inverse variable length coding the extracted compressed multimedia information to generate quantized frequency domain components of frame slices of a frame of multimedia information; c.) inverse quantizing the quantized frequency domain components of the frame slices to generate frequency domain components of the frame slices; d.) inverse transforming the frequency domain components of the frames slices to generate a plurality of frame slices; e.) combining the plurality of frame slices to form the frame of multimedia information; f.) converting the frame from a first color space to a second color space, wherein each component of the second color space is formed as a weighted combination of components of the first color space; and g.) displaying the converted frame on a display device.

According to the fourth aspect, the step of combining can comprise the step of: h.) replacing missing frame slices of the plurality of frame slices using corresponding frame slices from a previous frame. Frequency domain components of the frame slices can be inverse transformed into the plurality of frame slices using an inverse discrete cosine transform. The first color space can comprise a luminance and chrominance (YUV) color space, and the second color space can comprise a red, green, blue (RGB) color space. The method can include the step of: i.) adding porches surrounding an active portion of the frame.

A system and method are disclosed for communicating multimedia information. Exemplary embodiments provide a Video-to-Data (V₂D) element that can be used over private and/or public transmission networks. The V₂D elements can transfer multimedia information in, for example, Ethernet, IP, ATM, SONET/SDH or DS3 frame formats over Gigabit Ethernet, Fast Ethernet, Ethernet, IP networks, as well as optical carrier networks and ATM networks. The V₂D elements can use optimized video compression techniques to transmit high-resolution mono and stereoscopic images and other multimedia information through the network with high efficiency, high accuracy and low latency. The V₂D elements can interface with a visualization graphics server on one side and a network on the other. A plurality of multimedia visualization centers can be coupled to the network. Each multimedia visualization center can include, for example: (i) a V₂D element that transmits and/or receives compressed multimedia information; and (ii) multimedia presentation equipment suitable for displaying multimedia information, such as video and audio.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a multimedia immersive visualization system connected by Video-to-Data (V₂D) elements, in accordance with an exemplary embodiment of the present invention.

FIG. 2 is a flowchart illustrating steps for transmitting and receiving multimedia information through the network 125, in accordance with an exemplary embodiment of the present invention.

FIG. 3 is a diagram illustrating an external interface of a V₂D transmitter, in accordance with an exemplary embodiment of the present invention.

FIG. 4 is a diagram illustrating an external interface of a V₂D Receiver, in accordance with an exemplary embodiment of the present invention.

FIG. 5 is a data flow diagram and interface specification of a V₂D transmitter, in accordance with an exemplary embodiment of the present invention.

FIG. 6 is a data flow diagram and interface specification of a V₂D receiver, in accordance with an exemplary embodiment of the present invention.

FIG. 7 is a flowchart illustrating the steps performed by the V₂D transmitter compression module, in accordance with an exemplary embodiment of the present invention.

FIG. 8 is a flowchart illustrating the steps performed by the V₂D receiver uncompression module, in accordance with an exemplary embodiment of the present invention.

FIG. 9A is an illustration of a format of a video frame as constructed and transmitted using variable-length coding, in accordance with an exemplary embodiment of the present invention.

FIG. 9B is an illustration of a format of a video slices within a video frame as constructed and transmitted using variable-length coding, in accordance with an exemplary embodiment of the present invention.

### DETAILED DESCRIPTION OF THE PREFERRED EMBODIMENTS

A system and method are disclosed for compressing high bandwidth multimedia information for transmission over low bandwidth networks. As used herein, “multimedia information” can include any suitable type of audio, video and other data that can be transmitted over a network. Exemplary embodiments of the present invention provide Video-to-Data (V₂D) elements that can be used over private and/or public networks and can transfer multimedia information in, for example, Ethernet, DS3, or SONET/SDH frame formats or the like. The V₂D elements according to exemplary embodiments include a transmitter, referred to as a V₂D transmitter. The V₂D elements can also include a receiver, that can either be a hardware-based device, referred to as a V₂D receiver, or a software-based device, referred to as a V₂D client. The V₂D elements can use algorithms to reduce the bandwidth of high-resolution mono and stereoscopic images and other multimedia information efficiently with minimal visual artifacts. The V₂D elements can be placed in a public and/or private network that offers, for example, an end-to-end 10/100 Base-T Ethernet circuit or the like.

The V₂D elements can interface with a visualization graphics server on one side and an information transmission network (e.g., copper-based, optical, a combination of such, or the like) on the other. The V₂D elements provide a means for transmitting and receiving high-quality multimedia information at sub-gigabit rates using optimized video compression techniques. The embodiments presented herein can be applied to any suitable network, such as, for example, SONET/SDH, Gigabit Ethernet, Fast Ethernet, Ethernet, ATM, (routed) IP networks and the like. As used herein, the term “network” applies to any such suitable network.

According to exemplary embodiments, compressed multimedia information can be transferred between the V₂D elements, such as between a V₂D transmitter and a V₂D receiver or between a V₂D transmitter and a V₂D client. The V₂D transmitter can be located at one end of a network line and the V₂D receiver or client can be located at the other end. Compressed multimedia information can be transferred between a V₂D transmitter and multiple V₂D receivers or clients (referred to as multicast or broadcast). For example, the V₂D transmitter can located at one end of the network, while the V₂D receivers or clients are located at different locations throughout the network. Because the software-based V₂D client may not be able to process computations as fast as the hardware-based V₂D receiver can, exemplary embodiments can have dual video streams out of the V₂D transmitter, one a high-bandwidth video stream for the hardware-based V₂D receiver and the other a low-bandwidth video stream for the software-based V₂D client.

According to the present invention, sub-gigabit transmission of high resolution, high frame-rate stereo multimedia information can be achieved using multiple optimized compression techniques. These compression techniques can include, for example, frame dropping, color space conversion with chrominance sub-sampling in the horizontal direction, discrete cosine transformation followed by intelligent frame differencing that can include slice dropping, followed by quantization, and variable length coding.

Exemplary embodiments can slice each frame horizontally and/or vertically into smaller portions called “video slices.” These video slices from a left/right frame can then be compared with preceding video slices of the corresponding sections of the left/right frame. For example, if the difference between the compared video slices is within the configured system interface electronic noise levels, the video slice can be dropped and not transmitted. However, if the difference is large enough, the video slice can be further compressed and transmitted.

Frame dropping should not create any visual distortions. According to an exemplary embodiment, when a left frame of a stereo video is dropped, the corresponding right frame can also be dropped. A rate-control algorithm can ensure that left and right frames of stereo video are dropped uniformly and that the concomitant compression parameters are altered to the same extent so that the frames are similarly compressed, so that there are no visual artifacts in a 3-D video.

Exemplary embodiments of the present invention can employ slice dropping based on slice comparison, and can include an intelligent slice dropping technique referred to as “signature-based slice dropping.” In signature-based slice dropping, redundant video slices are dropped through the computation of feature vectors that describe the video slice. Examples of such feature vectors include the DCT coefficients of blocks in a video slice and the like.

Exemplary embodiments can use a band-pass filter to filter out the contribution due to noise introduced by an analog-to-digital converter and other interface circuits for the purposes of intelligent frame differencing and intelligent slice dropping. Such filtering can be performed in the frequency domain of the pixel data after the DCT calculation has been performed in the compression algorithm. The filter parameters can be user-settable. According to exemplary embodiments, on applications that require lossless transmission of video, the compression logic in the V₂D elements can be bypassed by the use of, for example, a selector multiplexer. Exemplary embodiments can handle transmission losses inherent to networks such as, for example, IP networks, through a periodic slice refresh (R-Slice) mechanism in which lost or corrupted I-slices can be replaced at set periodic intervals by R-Slices.

Exemplary embodiments can perform chrominance sub-sampling in the horizontal direction. Such a methodology is referred to as 4:2:2 sub-sampling. However, some applications require that no chrominance information is lost. For such applications, exemplary embodiments can provide a 4:4:4 sampling mode whereby the color information not sent in the I-slices can be sent in R-Slices. The V₂D receiver can receive color information for odd and even horizontal pixels in alternating R-Slices, and assimilate the information to reconstruct complete color information on the display side. The sub-sampling method can also be bypassed using a selector multiplexer and all the luminance and chrominance information can be preserved for further processing.

According to an exemplary embodiment, a technique referred to as “dual compression” can be used, where moving parts and static parts of an image can be compressed using different compression parameters. The present invention can detect small movements and consider those small movements as static parts of the screen for the purposes of using static compression parameters in a dual compression environment. According to another exemplary embodiment, a software control algorithm can be used to keep track of moving parts of the image to detect a change in status from large movements to small or no movements. Such an algorithm can also force a burst of refresh slices (R-Slices) with better compression parameters for the purpose of replacing all of the highly compressed parts of the image previously sent with better quality slices. According to an exemplary embodiment, the output video frame buffer size can be optimized to hold approximately one video frame. Data can be extracted from this buffer to be sent over, for example, a 10/100 base-T IP network or the like at a configured average rate. Furthermore, the rate at which data is transmitted over the transmission network can be controlled. If the rate at which data is generated after compression exceeds the configured average rate, then a rate control algorithm can begin to drop input video frames. Exemplary embodiments can also allow for an occasional burst of data on top of the configured average rate on the network as configured by, for example, the system or network administrator.

According to exemplary embodiments, network quality of service can be monitored on the V₂D receiver end or on the V₂D client end by means of counting dropped and/or corrupted video data due to network congestion. Statistical information can then be passed in the reverse channel back to the V₂D transmitter. The V₂D transmitter can use the statistical information to automatically rate control the amount of video data sent over the network.

According to exemplary embodiments, the connection setup between the V₂D transmitter and the V₂D receiver or V₂D client can be performed using a connection setup environment including a connection server, a connection client and a connection console to provide flexibility in controlling the connection set-ups and switching. A database of connection authorizations can be maintained, wherein a V₂D receiver or a V₂D client can be allowed to connect or prevented from connecting to a V₂D transmitter based on, for example, permissions set by the system or network administrator. Alternatively, network and compression parameters can be pre-assigned for use by the V₂D elements during a connection set-up.

According to an exemplary embodiment, the audio that is associated with the video can be synchronized to the video data at the receiving end, such as by buffering the audio data at the V₂D transmitter and transmitting the buffered audio data periodically at, for example, the end of every video frame.

According to a further exemplary embodiment, the phase of the sampling pixel clock can be automatically adjusted to minimize the noise contribution due to an incorrect sampling phase of the pixel clock used by the analog-to-digital converter to digitize analog pixel data. Phase adjustment of the pixel clock can be performed by, for example, incrementing or decrementing the phase of the pixel clock within the bounds of the analog-to-digital converter and determining the phase at which the least number of I-Slices are transmitted for the static portions of the screen.

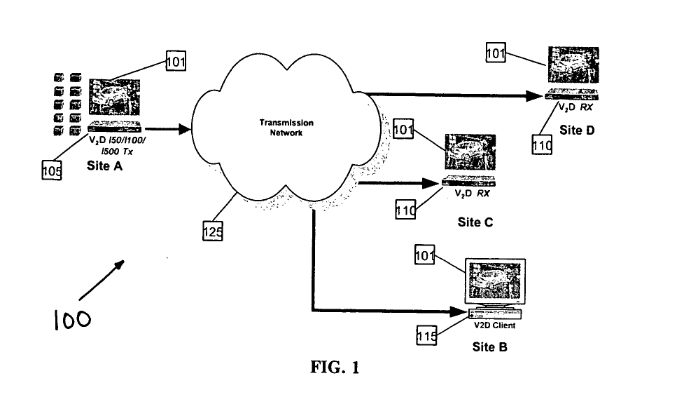

These and other aspects of the present invention will now be described in greater detail. FIG. 1 is a diagram illustrating a multimedia immersive visualization system 100 connected by V₂D elements, in accordance with an exemplary embodiment of the present invention. FIG. 1 illustrates an end-to-end system deployment scenario with multiple sites connected over an information transmission network. These sites can collaborate interactively in an immersive environment supported by the V₂D elements, according to exemplary embodiments of the present invention.

In FIG. 1, the V₂D elements can include a V₂D transmitter 105, a V₂D receiver 110, and a V₂D client 115. The V₂D transmitter 105 can be connected to a network 125 for switching and transport of information signals between one or more V₂D transmitters 105, and one or more V₂D receivers 110 and V₂D clients 115. Multimedia displays 101 can be connected to the V₂D receiver 110 and the V₂D client 115, such that there can be one or more multimedia displays for each V₂D receiver 110 and the V₂D client 115. Any number of sites can be configured for use in the system 100, with each site using any type of data or optical networking elements. In the network 125, appropriate transmission circuits (e.g., Ethernet, IP, ATM, DS3, OC-3, OC-12, OC-48, OC-192, and the like) can be provisioned to the destination sites.

For purposes of illustration and not limitation, in a unicast configuration, site A can be in communication with site B using the network 125. Site A can be in communication with site C or to site D, but not both site C and site D concurrently, using the network 125. Additionally or alternatively, the network 125 can be bypassed, and site A can be in direct communication with site B, or site A can be in direct communication with site C, or site A can be in direct communication with site D using suitable network transmission elements (e.g., a cross over cable). Other configurations of the system 100 are possible.

For purposes of illustration and not limitation, in a broadcast or multicast configuration, site A can be in communication with site B, site C and site D or other multiple sites concurrently by using suitable network multicast and/or broadcast methods and protocols.

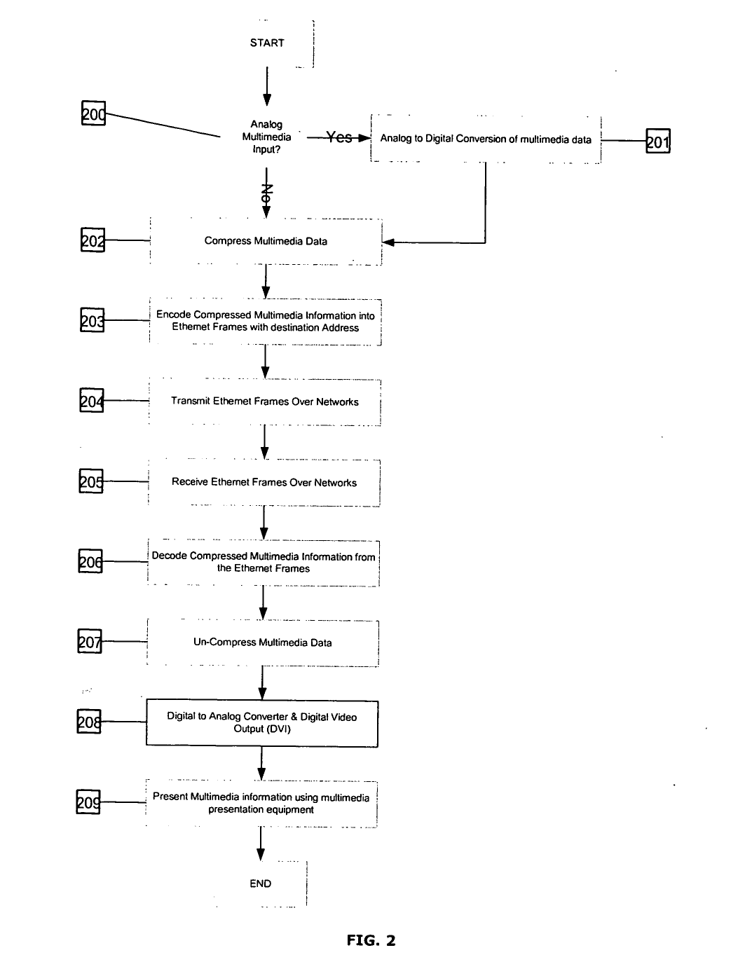

FIG. 2 is a flowchart illustrating steps for transmitting and receiving multimedia information through the network 125, in accordance with an exemplary embodiment of the present invention. Thus, FIG. 2 illustrates the steps for transmission and reception of multimedia information in an end-to-end system, from when data is transmitted by a V₂D transmitter 105 on the transmit side, to when it is decoded and displayed by the V₂D receiver 110 or V₂D client 115 on the receive side. In step 200, a determination can be made as to whether the multimedia information to be transmitted is in digital format or analog format. If the multimedia information is in analog format, then in step 201, the analog multimedia information can be converted to corresponding digital multimedia information using, for example, an analog-to-digital converter (ADC) or the like. In step 202, the digital multimedia information can be compressed. In step 203, the compressed multimedia information can be encoded into, for example, Ethernet frames or the like with appropriate destination addresses. In step 204, the Ethernet frames can be transmitted over the network.

In step 205, the Ethernet frames can be received from the network. In step 206, the compressed multimedia information that was encoded into the Ethernet frames can be decoded from the Ethernet frames. In step 207, the decoded multimedia information can be uncompressed. In step 208, the uncompressed multimedia information can be formatted into digital video interface (DVI) output and/or analog video format, using, for example, a digital-to-analog converter (DAC). In step 209, the decoded and uncompressed multimedia information can be presented using any suitable type of multimedia presentation equipment.

The V₂D elements according to exemplary embodiments can support any suitable number of combinations of resolution and refresh rates. The V₂D elements can be configurable to allow a user to select from a range of resolutions including, but not limited to, VGA, XGA (1024×768), SXGA (1280×1024) and UXGA (2048×1536) and the like. Similarly, the refresh rates can be selected from, for example, approximately 30 Hz to approximately 120 Hz or higher. In addition, the system 100 can be used to provide for RG_{S}B (sync on green), RGBS (composite sync), RGBHV (separate sync) or the like.

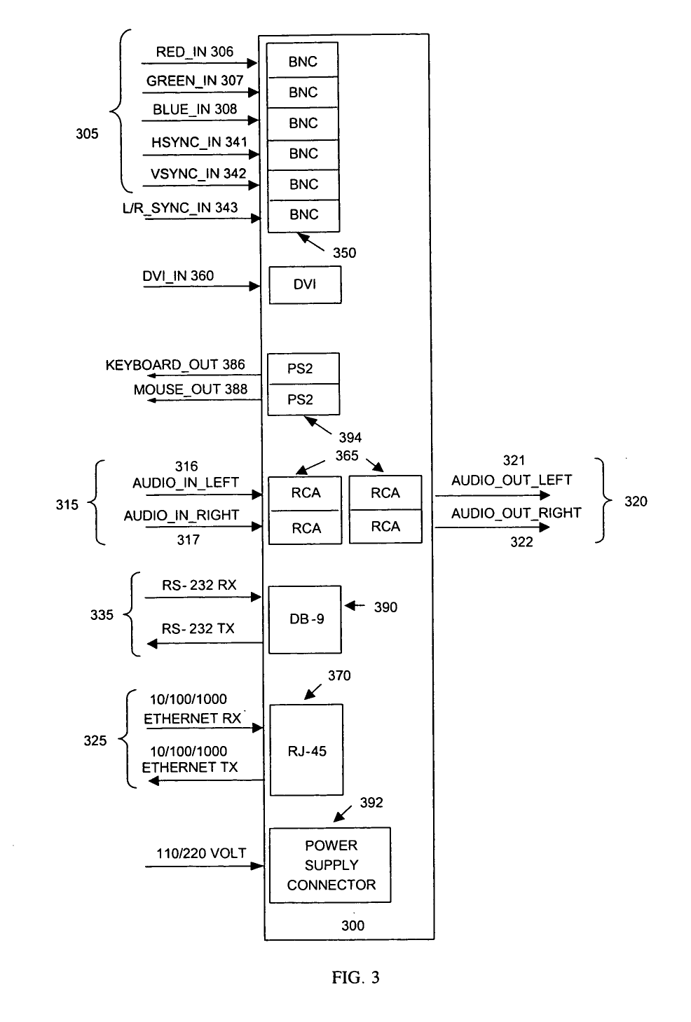

FIG. 3 is a diagram illustrating an external interface 300 of a V₂D transmitter 105, in accordance with an exemplary embodiment of the present invention. The V₂D transmitter 105 can transmit, for example, Ethernet packets or the like containing multimedia information, using a bi-directional port 325. As shown in FIG. 3, the external interface 300 can include one channel of input analog video 305 with three input colors red 306, green 307 and blue 308, along with input video synchronization signals HSYNC 341 and VSYNC 342. The external interface 300 can also include one channel of input Digital Video Interface (DVI) 360. In addition, the external interface 300 can include an input left/right sync pulse 343 that can be used for stereo video. The external interface 300 can include one channel of input stereo audio 315, including input left and right audio channels 316 and 317, respectively. The external interface 300 can include one channel of output stereo audio 320, including output left and right audio channels 321 and 322, respectively. The external interface 300 can also include one bi-directional RS-232 serial port 335. The external interface 300 can also include one channel of output keyboard data 386 and one channel of output mouse data 388. The external interface 300 can include one input power supply 392 of 110V or 220V, auto-switchable. Other configurations of the external interface 300 are possible, according to exemplary embodiments.

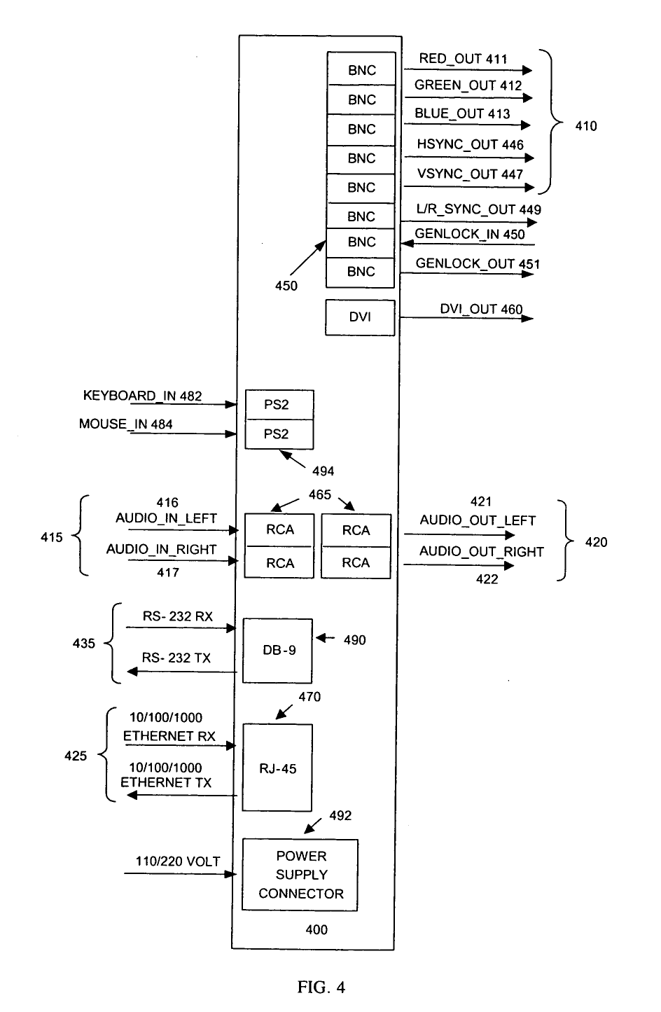

FIG. 4 is a diagram illustrating an external interface 400 of a V₂D receiver 110, in accordance with an exemplary embodiment of the present invention. The V₂D receiver 110 can receive, for example, Ethernet packets containing multimedia information, using a bi-directional port 425. As shown in FIG. 4, the external interface 400 can include a output channel of analog video 410 with three output colors red 406, green 407 and blue 408 along with horizontal 446 and vertical synchronization 447 pulses. The external interface 400 can include one channel of output DVI 460. In addition, the external interface 400 can include an output for left/right synchronization pulse 449 that can be used to drive, for example, stereographic emitters for stereo video. The external interface 400 can include one channel of input stereo audio 415, including left and right input audio channels 416 and 417, respectively. The external interface 400 can include one channel of output stereo audio 420, including left and right output audio channels 421 and 422, respectively. The external interface 400 can include one bi-directional RS-232 serial port 435. The external interface 400 can include a pair of input Genlock and output Genlock channels 450 and 451, respectively. The external interface 400 can also include one channel of input keyboard data 482 and one channel of input mouse data 484. The external interface 400 can include one input power supply 492 of 110V or 220V, auto-switchable. Other configurations of external interface 400 are possible, according to exemplary embodiments.

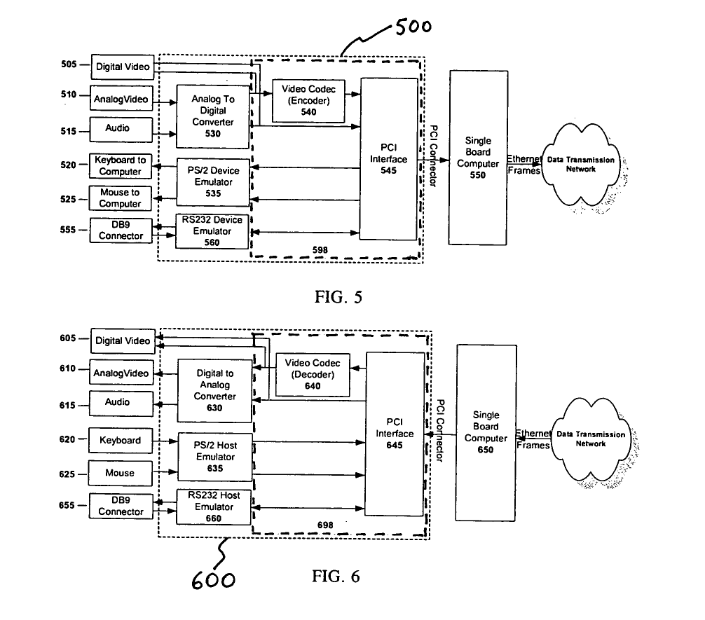

FIG. 5 is a data flow diagram and interface specification of the V₂D transmitter 500, in accordance with an exemplary embodiment of the present invention. A high-definition analog video input 510, with an option of, for example, stereoscopic video, can be sent to an Analog-to-Digital Converter (ADC) 530. The ADC 530 converts analog video into digital format. For digital video input 505, the ADC 530 can be bypassed. The digital video can be compressed using the video compression encoder 540 associated with the ASIC/FPGA 598. The compressed video can be combined with an associated stereo audio input 515, which can also be converted into digital format using ADC 530, if the audio is in analog format. The combination of high-resolution video and audio can form the multimedia information. The control of keyboard data 520 and mouse data 525 for the local computer (i.e., on the V₂D transmitter end) can be transferred from the remote V₂D receiver end to enable remote users to control the local computer. The V₂D transmitter 500 can act as, for example, a PS/2 device emulator 535 to the computer connected to it. The compressed video and audio can be multiplexed together in the ASIC/FPGA 598 to form the multimedia information stream. The multimedia information stream can be transferred to the single board computer (SBC) 550 over the Peripheral Control Interface (PCI) 545. The SBC 550 can construct Ethernet frames and transfer those Ethernet frames to the remote receiver end via, for example, an Ethernet network. The SBC 550 can transmit Ethernet frames containing multimedia information based on the average and burst transmission rates configured by the system administrator and on rate limits on the data transfer between the ASIC/FPGA 598 and the SBC 550 over the PCI bus 545. The rate limitation algorithm defines the number of frames processed and transmitted per second.

FIG. 6 is a data flow diagram and interface specification of the V₂D receiver 600, in accordance with an exemplary embodiment of the present invention. The single board computer 650 can receive Ethernet frames transmitted by a V₂D transmitter and can transfer those frames to the ASIC/FPGA 698 over the PCI interface 645. The ASIC/FPGA 698 then de-multiplexes the multimedia information stream to form compressed video and audio outputs. The compressed video output is then uncompressed using the video decoder codec 640 associated with the ASIC/FPGA 698. The uncompressed video and audio data are then converted back to the original analog format using a Digital-to-Analog Converter (DAC) 630. The analog video and audio data are then sent out as analog video signal 610 and analog audio signal 615. The uncompressed digital video can also be sent out in DVI format 605. The V₂D receiver 600 can act as a computer (e.g., PS/2 or the like) host emulator 635 to the keyboard 620 and mouse 625 connected to it, and can encode the keyboard strokes and mouse movements into packets. The keyboard and mouse movement packets can be communicated back to the V₂D transmitter 500 to control the keyboard and mouse of the remote computer.

Two parameters that can be used for configuring the V₂D transmitter are the refresh rate and resolution. The refresh rate is the rate at which a new screen is projected on a monitor's CRT screen, expressed in Hertz, and is reflected in the frequency of the VSYNC (vertical synchronization) signal, that comes directly from any standard video card.

The format of a screen is determined using HSYNC and VSYNC pulses. HSYNC denotes when a new line of pixels is to be projected onto a monitor's CRT screen. When a VSYNC pulse arrives, the monitor starts at the top of the screen, and when an HSYNC pulse arrives, the monitor starts at the beginning of a new line. Using a counter that runs off a known clock with fixed frequency (e.g., 38.88 MHz), the number of clock cycles between rising edges of VSYNC is measured to determine the refresh rate. The number of HSYNC pulses between VSYNC pulses is counted to determine the number of vertical lines in the video. In addition, the width of the VSYNC pulse is determined by counting the number of clock cycles between the rising and falling edges of the VSYNC pulse. Finally, a counter counts the time between HSYNC pulses to determine the frequency of the HSYNC pulses.

Using information obtained from the refresh rate, the frequency of HSYNC pulses, the number of vertical lines in a video and the VSYNC pulse width, a matching entry can be found in a user-configured video look-up table that can be stored on, for example, the V₂D transmitter. The look-up table can include other information needed to configure the V₂D transmitter, such as, for example, pixel clock, number of pixels in a horizontal line of video, active horizontal pixels, active vertical pixels, horizontal front porch, horizontal back porch, vertical front porch, vertical back porch and the like.

Various techniques can be used for reducing the required bandwidth for high resolution and high refresh rate multimedia information. Details of several of these techniques are described in, for example, “Video Demystified: A Handbook for the Digital Engineer,” by Keith Jack, pages 219, 311-312 and 519-556. Some of these techniques include, for example: RGB color depth reduction; RGB-to-YUV and YUV-to-RGB conversions; frame dropping, where the image is displayed at the same rate as the original, but transmission rate is reduced by not transmitting all the frames, motion estimation based on commercially available cores such as MPEG2, MPEG4, H.26× and the like; discrete cosine transformation; quantization; and variable length coding. However, other techniques can be used to reduce the required bandwidth for high resolution and high refresh rate multimedia information.

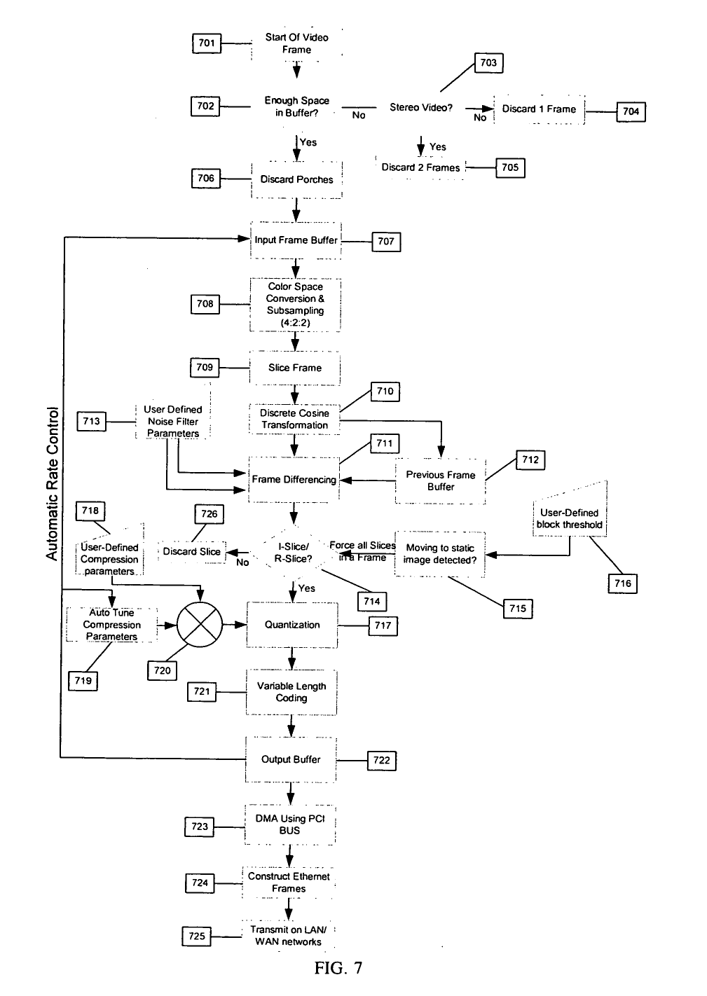

FIG. 7 is a flowchart illustrating the steps performed by the V₂D transmitter compression module, in accordance with an exemplary embodiment of the present invention. In sum, based on input from the rate control mechanism, a determination is made as to whether to process the current frame, or to discard the frame and wait for the next frame. Once a frame is taken up for encoding, it is converted to the YUV color space from the RGB color space. The frame is sliced into small parts and each color component is then converted into frequency domain through the discrete cosine transformation (DCT). The DCT components are then compared to the corresponding values of the previous frame to get a difference result. The difference result is then compared against user set thresholds to determine if the slice has to be further processed as an I-Slice. In addition, a decision is also made as to whether to force send the slice as a refresh slice (R-Slice). If the decision algorithm results in sending the slice as an I-Slice or an R-Slice, quantization is performed on the original DCT coefficients. If the decision algorithm results in not sending the slice as an I-Slice or an R-Slice, the slice is discarded and not processed any further. The choice of quantizer could be set either by the user, or through the automatic rate control mechanism. The outputs of the quantizer are variable length encoded and are transferred from the ASIC/FPGA memory into the processor memory by, for example, Direct Memory Access (DMA). The processor can then pack the compressed data into Ethernet frames and transmit those frames on the transmission network.

More particularly, in step 701, the start of a video frame is detected. In step 702, a determination is made as to whether there is enough space to fit one video frame in the input frame buffer. If there is not enough space in the input frame buffer, then in step 703, a determination is made as to whether the input video is in stereo format. If not in stereo format, then in step 704, one complete frame is discarded for mono video, otherwise, in step 705, two complete frames, both left and right eye pair, are discarded for the stereo video. If there is enough space in the input frame buffer, or after video frames have been discarded, then in step 706, the porches surrounding the active area of the video are discarded. In step 707, only active portions of the video are written into the input frame buffer, resulting in a compression factor of, for example, 40% or more depending on the format of the video.

In step 708, data in the input frame buffer is transformed into a color space in which the properties of the human visual system can be exploited. For example, the Red (R), Green (G) and Blue (B) components (RGB) of the video samples can be converted to Luminance (Y) and Chrominance (UV) samples (YUV). Such a conversion can be considered a linear transform. Each of the YUV components can be formed as a weighted combination of R, G and B values: The equations that can be used in the transform are, for example, given in Equations (1):
Y=0.257R+0.504G+0.098B+16
U=−0.148R−0.291G+0.439B+128
V=0.439R−0.368G−0.071B+128
For finite precision implementation, the coefficients used in Equations (1) can be approximated to rational fractions, with the denominator being the power of two that correspond to the required precision. For example, 0.257 can be approximated as 16843/65536 for a 16-bit implementation. However, other color transformation equations can be used, along with other coefficients, depending on the nature and type of video content being processed, the hardware specifications of the system, and the like.

Based on the nature of the content of the video, the chrominance can be sub-sampled in the horizontal and vertical directions. For natural images, such sub-sampling can work well, since the color gradients are small. For images created by visualization systems, the color transitions are much more pronounced and the color information should be preserved as close to the original as possible. For this reason, the V₂D transmitter according to exemplary embodiments can perform sub-sampling in step 708 of chrominance in the horizontal direction for the purpose of compression (4:2:2), or not at all (4:4:4).

In step 709, the video frame can be divided into smaller segments, known as “slices.” The size of the slice can be chosen based on, for example, the video resolution, so that the number of slices in a video frame is an integer and not a fraction. The size of a slice can be chosen to be between, for example, 8 and 128 blocks, inclusive, for optimal performance, where each block can be comprised of, for example, and 8×8 pixel data block. However, a slice can be any desired size, depending on the nature of the application and the like.

In step 710, using a discrete cosine transform (DCT), an 8×8 pixel data block of chrominance and luminance can be transformed into an 8×8 block of frequency coefficients using the following Equation (2):

$$F ( u , υ ) = \frac{{C}_{u}}{2} \frac{{C}_{υ}}{2} {\sum }_{y = 0}^{7} {\sum }_{x = 0}^{7} f ( x , y ) cos [ \frac{( 2 x + 1 ) u π}{16} ] cos [ \frac{( 2 y + 1 ) υπ}{16} ] \\ with \text{:} \\ {C}_{u} = \{ \begin{matrix}\frac{1}{\sqrt{2}} & if u = 0 , \\ 1 & if u > 0\end{matrix} ; {C}_{υ} = \{ \begin{matrix}\frac{1}{\sqrt{2}} & if v = 0 , \\ 1 & if v > 0\end{matrix} \qquad ( 2 )$$

In Equation (2), f(x,y) represent the samples of the Y, U or V block, and F(u,v) represents the DCT coefficient corresponding to each of those samples.

After performing a DCT on a complete slice, in step 711, frame differencing is performed. More particularly, the resulting values from the DCT are subtracted from the determined values from the DCT of the corresponding slice from the previous frame that are stored in a previous input frame buffer, with the previous frame being provided by step 712. Additionally in step 712, the results of the current DCT values of the slice are written into the corresponding slice location of the previous frame buffer for frame differencing operation on the next frame. In step 713, the outputs of the differences (referred to as difference DCT values) between the slice of current frame and the corresponding slice of the previous frame are compared against user-defined noise filter parameters to eliminate the effects of any noise contribution due to cables or electronic components, such as, for example, ADCs and the like. Difference DCT values are used for the purpose of frame differencing.

According to exemplary embodiments, DCT frequency components contributed by electronic and cable noise are filtered out for the purposes of frame differencing, as described previously. The filtering is performed by sending the difference DCT values through, for example, a band-pass filter. The low frequency components of an 8×8 pixel data block can reside in the upper left portion of the 64-value matrix, while the high frequency values can reside in the lower right portion of the 64-value matrix. By choosing the appropriate band-pass filter parameter values, the noise contributed to these 64 difference DCT values of the 8×8 pixel block can be zeroed by dividing the low frequency and high frequency difference DCT values with the corresponding low frequency and high frequency filter parameters and truncating the results to the nearest integer. If after this division, all the 64 values become zero, a decision can be made that the block that is being compared to the previous frame is the same as the previous frame. If all of the blocks in a slice are the same as the blocks in the slice of the previous frame, the slice is considered substantially identical to the previous frame.

The ADC can sample the analog data using a clock that is substantially identical to the pixel clock frequency at which the video is generated by a video source, such as, for example, a graphics card inside a computer. The pixel clock can be generated by, for example, multiplying the HSYNC signal by a known integer value. The phase of the sampling pixel clock must be aligned to the data that is being sampled. According to exemplary embodiments, an automatic phase adjustment of the sampling pixel clock can be provided to the user through a user menu. The automatic phase adjustment can be performed by, for example, monitoring the number of slices transmitted as I-Slices, while incrementing or decrementing the phase of the sampling clock in small increments. An incorrect sampling phase may incorrectly generate more I-Slices in the static parts of the video frame, while a correct sampling phase would ideally generate zero I-Slices in the static parts of the video frame. The phase of the sampling pixel clock at which the least number of slices is sent is chosen as the “correct” sampling phase. The correct sampling phase can then be used to sample all of the incoming pixels by the ADC.

In step 714, if a determination is made to not send the slice as an I-Slice, because the slice is the same as the previous slice, a decision is made whether to send the slice as a periodic update refresh slice (R-Slice). R-Slices can be sent in a round robin method, where sets of slices are selected and marked as R-Slices. For example, a slice counter can keep track of which slices should be sent out as R-Slices. The slice counter can be incremented each time a new frame is sent, and can roll to zero when all slices in a frame are sent out as R-Slices, thereby beginning counting again. The amount of increment at which the counter updates determines the number of slices to be sent out as R-Slices in each frame. For example, if the counter increments by one every new frame, one R-Slice is sent out every frame. However, if the counter increments by five every new frame, five R-Slices are sent out each frame. The number by which the counter increments can be user programmable. Consequently, all the parts of the frame can be updated periodically and continuously.

In step 714, if a determination is made to not send the slice as either an I-Slice or an R-Slice, the slice can be discarded in step 726 and no further processing is performed. Since, in general, most portions of the video can be static between frames, discarding redundant static parts and updating those parts of video that are changing from one frame to the next can result in greater amounts of video compression. For example, small movements based on user-defined block thresholds supplied by step 716 can be considered static. In step 715, when it is detected that the video content has changed status from moving to static, such information can be provided to step 714 to send, for example, all slices in one frame as R-Slices (e.g., using ASIC/FPGA 598).

A slice difference counter can keep track of how many slices in a frame are sent out as I-Slices. These slices contain moving parts of the image and are different from the corresponding slices of the image in the preceding frame. The slice difference counter increments each time there is a new I-slice in the frame. The difference counter can be reset to zero at the start of a new frame. When the value of the difference counter transitions from a high value to a low value, as defined by user settable parameters, R-Slices can be forced for a complete frame. The difference counter does not increment when the number of changed blocks (e.g., 8×8 pixels) that are contained in a slice are less than a block threshold parameter defined by the user in, for example, the user-settable parameters. This ensures that small movements in a video, for example, mouse movements, do not trigger the “Force All Slices in One Frame” determination provided by step 715.

The original DCT values of I-Slices and R-Slices computed in step 710 can be further processed in step 717 through quantization. There are two components to quantization. First, the human visual system is more sensitive to low frequency DCT coefficients than high frequency DCT coefficients. Therefore, the higher frequency coefficients can be divided with larger numbers than the lower frequency coefficients, resulting in several values being truncated to zero. The table of, for example, 64 values that can be used for dividing the corresponding 64 DCT frequency components in an 8×8 block, according to an exemplary embodiment, can be referred to as quantizer table, although the quantizer table can be of any suitable size or dimension. The second component to quantization is the quantizer scale. The quantizer scale is used to divide all of the, for example, 64 DCT frequency components of an 8×8 pixel data block uniformly, resulting in control over the bit-rate. Based on the quantizer scale, the frame can consume more bits or fewer bits.

According to exemplary embodiments, two different values for the quantizer scale can be used, one assigned to I-Slices and another assigned to R-Slices. In general the I-Slice quantizer scale value can be greater than or equal to the R-Slice quantizer scale value. In general, the human eye is less sensitive to changing parts of a video image compared to the static parts of the video image. The human eye sensitivity can be taken advantage of to reduce the transmission bitrate by compressing the changing parts of the video image (I-Slices) to a higher extent than the static parts of the video image (R-Slices). Compressing I-Slices to a higher extent than the R-Slices can result in better visual quality of R-Slices compared to the I-Slices. In addition, when the moving parts of the image become static, the static parts of the image can be quickly refreshed by better visual quality R-Slices, as defined by the methods described previously. According to exemplary embodiments, the same visual quality can be maintained for a reconstructed three-dimensional (3-D) image in case of stereo video. To achieve this, the quantization parameters used for I-Slices and R-Slices for both left and right frames of stereo video can be kept substantially identical.

The V₂D transmitter can utilize a quantizer table with values that are powers of, for example, two. Similarly, the quantizer scale that divides all of the 64 values in a block can use values that are power of, for example, two. By rounding the values of the quantizer table and the values of quantizer scale to powers of two, the need for dividers and multipliers in the quantizer module can be eliminated, thereby greatly speeding up the module and reducing hardware complexity. Consequently, divisions can be achieved by right shifting the DCT results, while multiplications can be achieved by left shifting the DCT results.

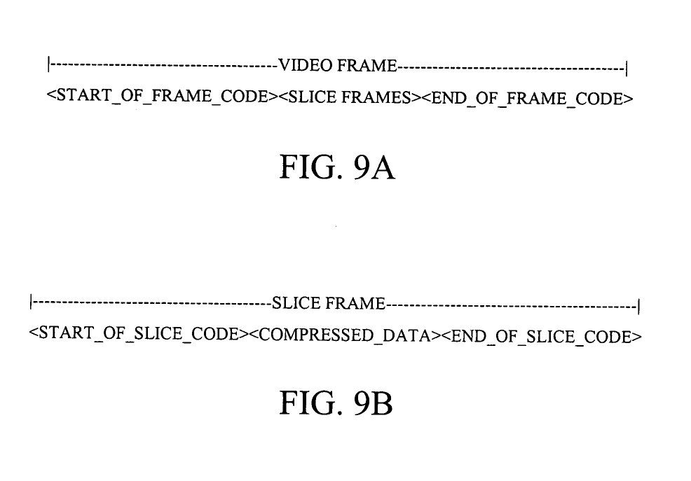

In step 721, a variable-length coding (VLC) scheme can be used to encode the multimedia information. Based on probability functions, VLC schemes use the shortest code for the most frequently occurring symbol, which can result in maximum data compression. Each video frame can be constructed and transmitted by the VLC scheme in step 721 in the format illustrated in FIG. 9A, in accordance with an exemplary embodiment of the present invention. In FIG. 9A, the “start of frame code” and “end of frame code” words uniquely identify the frame as left frame or right frame in the case of a stereo video. In the case of a mono video, all frames can be formatted as left frames.

Video Slices within a video frame can be constructed by the VLC in step 721 in the format illustrated in FIG. 9B, in accordance with an exemplary embodiment of the present invention. The “start of slice code” can have, for example, the following information that uniquely identifies the slice properties:
(a) Slice number: The sequential slice number that identifies the part of the video frame to which the slice belongs;
(b) Stereo Properties: A bit that represents whether the slice belongs to a left frame or a right frame;
(c) I-Slice/R-Slice: A bit that represents whether the slice is an I-Slice or an R-Slice;
(d) Quantization Parameters: A byte that represents the quantization scale values used during the process of compression.
   The “end of slice code” signals to the V₂D receiver an end of slice information. The “end of slice code” can also contain the slice number, which is used by the V₂D receiver as one of the parameters for identifying slices that are corrupted due to transmission errors.

According to exemplary embodiments, the “start of frame code,” “end of frame code,” “start of slice code” and “end of slice code” are unique and do not appear in any of the compressed data. Additionally, the aforementioned code words can be uniquely identified on a 32-bit boundary for synchronization purposes at the V₂D receiver.

Video compression is inherently variable bitrate (VBR). Different frames can have different amounts of information, and, based on the differing amounts of information, the compression ratios for those frames will be different. Buffer memory known as an output frame buffer is used between the encoder and the transmission channel so that compressed video of VBR can be read out at an average constant bitrate (CBR). Therefore, the buffer size can be optimized to accommodate at least one frame to be transmitted over time at the configured CBR. If the memory buffer becomes full, a decision to either drop a frame or reduce frame quality can then made.

Continuing with the flowchart of FIG. 7, in step 722, the compressed multimedia information is written by the VLC into the optimized output buffer. The output frame buffer can be a circular memory. When the output data rate is slower than the input data rate coming into the output frame buffer, the buffer can start to become full. When the data in the output frame buffer crosses a substantially full threshold, a signal can be sent to the input frame buffer to stop sending further multimedia information for the purposes of compression. Such a signal stops further computations and flow into the output frame buffer. Multimedia information flow from the input frame buffer into the compression blocks resumes when the remaining data in the output frame buffer crosses a lower threshold boundary and the output frame buffer can accept further data.

According to exemplary embodiments, the quantization scale values of both I-Slices and R-Slices can be automatically adjusted based on the frequency at which the output frame buffer crosses the substantially full threshold. In an ideal situation where there is enough network bandwidth available for transmission of compressed video, the data in the output frame buffer should never cross the substantially full threshold. However, if the available bandwidth for transmission is not large enough to accommodate the data after compression, further data compression can be achieved by increasing the quantizer scale values provided by the auto tune compression parameters in step 719. In other circumstances, data produced after compression might under-utilize available bandwidth for transmission. In such cases, quantizer scale values can be reduced to produce more data after compression while improving visual quality of the image. According to an exemplary embodiment, the auto tune compression parameters provided in step 719 can be overridden and bypassed, and the quantizer scale values can be set to the user-defined compression parameters in step 718.

In step 723, the data from the output frame buffer is then transferred to the processor memory through, for example, Direct Memory Access (DMA) using a PCI bus for further processing. DMA provides for fast transfers of large sets of data between memory elements with minimal processor cycles, thereby freeing up processor cycles for other tasks. According to exemplary embodiments, the rate at which the DMA transfers are performed can be controlled. The DMA transfer rate can be controlled by a rate control algorithm. The rate control algorithm ensures that the data flowing out of the V₂D transmitter is always within the user-specified parameters. The user-specified parameters include, for example, maximum average rate over a period of time and maximum burst rate over a short time. The user-specified maximum average rate and maximum burst rate dictate the flow of Ethernet data out of the V₂D transmitter and into the transmission network to which it is connected.

According to an exemplary embodiment, feedback can be received from the V₂D receiver about the network characteristics or statistics, such as, for example, the number of corrupted or dropped slices over the network due to network congestion. The statistics obtained from such a feedback mechanism can be used by the rate control algorithm to either decrease or increase the transmission rate. If there are many dropped or corrupted slices over a given period of time, the rate at which compressed multimedia information is extracted out of the output frame buffer using DMA is slowly reduced in small increments until the number of error or dropped slices is reduced close to zero. Network congestion is sometimes a temporary effect and can go away over time. In cases where the data flowing out of the V₂D transmitter is less than the user-specified maximum average rate, the rate at which the data is extracted from the output frame buffer is slowly increased in small increments back to the user-specified maximum average rate, while the feedback statistics are monitored. Sometimes, the data rate generated after compression is less than the maximum average rate set by the user. In such cases, the rate at which the Ethernet packets are transmitted can be set to the rate at which compressed multimedia information is generated.

In step 724, information that is written from the ASIC/FPGA output frame buffer into the processor memory is formatted into valid Ethernet packets, or any suitable network packet, with a destination IP address(es). The destination IP address can be set by the user in a menu interface provided by the system supporting the V₂D transmitter. In addition, if a multicast or a broadcast option is selected in the user menu, the Ethernet packets can be transmitted using the destination broadcast/multicast group IP address(es).

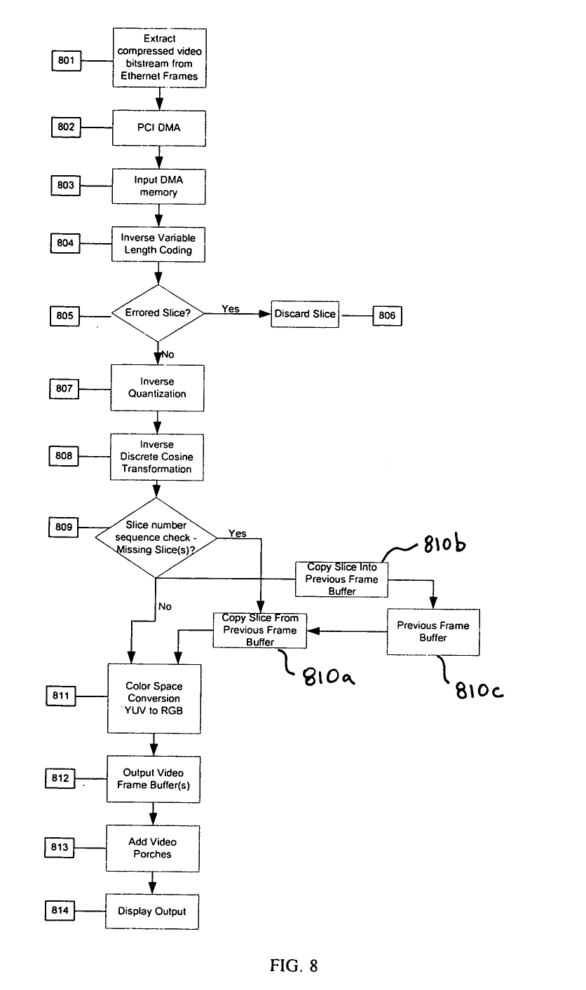

FIG. 8 is a flowchart illustrating the steps performed by the V₂D receiver uncompression module, in accordance with an exemplary embodiment of the present invention. In sum, the compressed bitstream is extracted from Ethernet payloads by the processor. The processor then performs a DMA into the compression FPGA/ASIC memory. After performing inverse variable length coding, a sanity check is made to see if the received slice is valid and not corrupted due to transmission errors. If no errors are detected, an inverse quantization (IQUANT) and inverse discrete cosine transformation (IDCT) is performed. If errors are detected, the slice is discarded and no further processing is performed. Missing slices are then replaced by slices from the previous frames stored in the previous frame buffer. The resulting IDCT bit stream is then converted from YUV to RGB and then sent to a display device from the output frame buffers.

More particularly, in step 801, Ethernet packets containing compressed multimedia information are received. The compressed multimedia information is then extracted from the received Ethernet packets and is stored in the processor memory in step 802. In step 803, depending on the fullness of the buffer of the input DMA memory of the ASIC/FPGA, the compressed data is transferred from the processor memory to the input DMA memory using PCI DMA.

In step 804, data is pulled from the input DMA memory by Inverse Variable Length Coding (IVLC) for further processing. The IVLC scans for valid frame headers and slice headers, in addition to decoding the code words generated by the VLC in the V₂D transmitter. According to exemplary embodiments, the left frame data can be distinguished from the right frame data by the IVLC based on the frame headers. All of the compressed data that is contained between the start of the left frame and the end of the left frame can be decoded as left frame data, while all of the data contained between the start of the right frame and the end of the right frame can be decoded as right frame data. In step 805, the IVLC checks for any corrupted slices due to transmission errors. For example, the detection of corrupted slices can be performed using the following checks during the decoding process:
(a) The total numbers of blocks within a slice that are decoded match the blocks per slice configuration;
(b) The number of pixels decoded in each block of a slice is equal to 64; and
(c) The slice number in the start of slice header matches the slice number in the end of slice header after all of the blocks in a slice are decoded.
   If any one of the above three conditions are violated, the slice is considered to be an error or corrupted slice, then in step 806, the corrupted slice is discarded and no further processing is performed on the slice.

The quantization scale values of each slice are extracted from the slice headers and are then passed to the Inverse Quantization (IQUANT) in step 807, along with IVLC decoded data of the corresponding slice. The order of the steps used in the quantization step 717 of FIG. 7 are reversed in the IQUANT of step 807. In step 808, the results of the IQUANT are passed to the inverse discrete cosine transformation.

The inverse discrete cosine transform (IDCT) converts the pixels back to their original spatial domain through the following Equation (3):

$$f ( x , y ) = {\sum }_{u = 0}^{7} {\sum }_{υ = 0}^{7} F ( u , υ ) \frac{{C}_{u}}{2} \frac{{C}_{υ}}{2} cos [ \frac{( 2 x + 1 ) u π}{16} ] cos [ \frac{( 2 y + 1 ) υπ}{16} ] \qquad ( 3 )$$

In step 809, the IDCT values are passed to a slice number sequence check, where slice numbers are checked for missing or dropped slices. If a missing slice is detected in step 809, then in step 810a, the corresponding slice from the previous frame in the previous frame buffer is copied and used to replace the missing slice. The missing slice can be the result of, for example, slice dropping, intelligent frame differencing or due of a corrupted slice resulting from transmission errors. In steps 810b and 810c, the results of a successfully-decoded IDCT slice are copied into the previous frame buffer. The previous frame buffer can store a complete frame and can update corresponding slices of the complete frame as successfully decoded IDCT values of slices are received. The slice number sequence check of step 809 ensures that all of the slices that make up a complete frame are passed on to the color space conversion.

In step 811, the color space conversion block converts the pixel color information from YUV back to the RGB domain using known algorithms. In step 812, the RGB values are transferred into an output video frame buffer. Data from the output video frame buffer is pulled out at a constant frequency. In step 813, the original porches that were discarded during compression by the V2D transmitter in step 706 of FIG. 7 can be added back to the active video. In step 814, the video image data can be displayed onto a display output, such as a monitor or other suitable type of multimedia display device.

According to exemplary embodiments, the look-up-table values that define the video parameters can be received by the V₂D receiver and can be used to reconstruct the original image before displaying it onto the display output. Some of the video parameters that can used are, for example:
(a) The pixel clock that determines the rate at which the data is to be extracted from the video frame buffer;
(b) The refresh rate that determines the rate at which the video is to be refreshed every second onto the display output;
(c) Porches information that is used to reconstruct the original video before display onto the display output; and
(d) Generation of video synchronization pulses for driving the display output.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

1. A system for transmitting multimedia information via a network, comprising:
means for retrieving a frame of multimedia information for transmission over the network;
means for converting the frame from a first color space to a second color space,
wherein each component of the second color space is formed as a weighted combination of components of the first color space;
means for slicing the frame into a plurality of frame slices;
means for transforming each of the plurality of frame slices into a plurality of corresponding frequency domain components;
means for quantizing the frequency domain components of each frame slice when it is determined that each frame slice is to be processed as one of an intra-slice and a refresh slice to generate quantized frequency domain components of each frame slice;
means for variable-length encoding the quantized frequency domain components of each frame slice to generate compressed multimedia information associated with each frame slice;
means for constructing network packets of the compressed multimedia information associated with each frame slice; and
means for transmitting the network packets via the network.

2. The system of claim 1, wherein the means for retrieving comprises:
means for discarding a retrieved frame based on at least one of a size of a frame buffer for storing the retrieved frame and a rate at which frames are transmitted.

3. The system of claim 1, comprising:
means for discarding porches surrounding an active portion of the frame.

4. The system of claim 1, wherein the first color space comprises a red, green, blue (RGB) color space, and
wherein the second color space comprises a luminance and chrominance (YUV) color space.

5. The system of claim 4, comprising:
means for sub-sampling chrominance of the frame in a horizontal direction.

6. The system of claim 1, wherein each of the plurality of frame slices is transformed into the plurality of corresponding frequency domain components using a discrete cosine transform.

7. The system of claim 1, comprising:
means for subtracting the frequency domain components of each frame slice from frequency domain components of a corresponding frame slice associated with a previous frame to generate a frame difference.

8. The system of claim 7, comprising:
means for comparing the generated frame difference against predetermined noise filter threshold parameters to determine whether noise is associated with each frame slice.

9. The system of claim 8, comprising:
means for canceling a noise contribution from the frame difference, to determine whether the frame slice is substantially identical to the corresponding frame slice associated with the previous frame.

10. The system of claim 1, comprising:
means for determining whether each frame slice is to be one of (i) discarded and (ii) transmitted as one of the intra-slice and the refresh slice.

11. The system of claim 10, wherein the means for determining comprises:
means for characterizing a feature within the frame as static when one of (i) the feature within the frame is substantially identical to a feature associated with a previous frame and (ii) movement of the feature within the frame is below a predetermined threshold;
means for detecting a change in status of the feature within the frame from static to moving; and
means for assigning all frame slices of the frame as refresh slices when the change in status is detected.

12. The system of claim 1, wherein the means for quantizing comprises:
means for modifying an amount of quantization based on available bandwidth for transmitting.

13. The system of claim 1, wherein the network packets comprise Ethernet packets.

14. The system of claim 1, wherein the means for transmitting comprises:
means for receiving network statistic information associated with transmission of the network packets; and
means for modifying a transmission rate of the network packets based on the received network statistic information.

15. A system for receiving multimedia information transmitted via a network, comprising:
means for extracting compressed multimedia information from network packets received via the network;
means for inverse variable length coding the extracted compressed multimedia information to generate quantized frequency domain components of frame slices of a frame of multimedia information;
means for inverse quantizing the quantized frequency domain components of the frame slices to generate frequency domain components of the frame slices;
means for inverse transforming the frequency domain components of the frames slices to generate a plurality of frame slices;
means for combining the plurality of frame slices to form the frame of multimedia information;
means for converting the frame from a first color space to a second color space,
wherein each component of the second color space is formed as a weighted combination of components of the first color space; and
means for displaying the converted frame.

16. The system of claim 15, wherein the means for combining comprises:
means for replacing missing frame slices of the plurality of frame slices using corresponding frame slices from a previous frame.

17. The system of claim 15, wherein frequency domain components of the frame slices are inverse transformed into the plurality of frame slices using an inverse discrete cosine transform.

18. The system of claim 15, wherein the first color space comprises a luminance and chrominance (YUV) color space, and
wherein the second color space comprises a red, green, blue (RGB) color space.

19. The system of claim 15, comprising:
means for adding porches surrounding an active portion of the frame.

20. A method of transmitting multimedia information via a network, comprising the steps of:
retrieving a frame of multimedia information for transmission over the network;
converting the frame from a first color space to a second color space,
wherein each component of the second color space is formed as a weighted combination of components of the first color space;
slicing the frame into a plurality of frame slices;
transforming each of the plurality of frame slices into a plurality of corresponding frequency domain components;
quantizing the frequency domain components of each frame slice when it is determined that each frame slice is to be processed as one of an intra-slice and a refresh slice to generate quantized frequency domain components of each frame slice;
variable-length encoding the quantized frequency domain components of each frame slice to generate compressed multimedia information associated with each frame slice;
constructing network packets of the compressed multimedia information associated with each frame slice; and
transmitting the network packets via the network.

21. The method of claim 20, wherein the step of retrieving comprises the step of:
discarding a retrieved frame based on at least one of a size of a frame buffer for storing the retrieved frame and a rate at which frames are transmitted.

22. The method of claim 20, comprising the step of:
discarding porches surrounding an active portion of the frame.

23. The method of claim 20, wherein the first color space comprises a red, green, blue (RGB) color space, and
wherein the second color space comprises a luminance and chrominance (YUV) color space.

24. The method of claim 23, comprising the step of:
sub-sampling chrominance of the frame in a horizontal direction.

25. The method of claim 20, wherein each of the plurality of frame slices is transformed into the plurality of corresponding frequency domain components using a discrete cosine transform.

26. The method of claim 20, comprising the step of:
subtracting the frequency domain components of each frame slice from frequency domain components of a corresponding frame slice associated with a previous frame to generate a frame difference.

27. The method of claim 26, comprising the step of:
comparing the generated frame difference against predetermined noise filter threshold parameters to determine whether noise is associated with each frame slice.

28. The method of claim 27, comprising the step of:
canceling a noise contribution from the frame difference, to determine whether the frame slice is substantially identical to the corresponding frame slice associated with the previous frame.

29. The method of claim 20, comprising the step of:
determining whether each frame slice is to be one of (i) discarded and (ii) transmitted as one of the intra-slice and the refresh slice.

30. The method of claim 29, wherein the step of determining comprises the steps of:
characterizing a feature within the frame as static when one of (i) the feature within the frame is substantially identical to a feature associated with a previous frame and (ii) movement of the feature within the frame is below a predetermined threshold;
detecting a change in status of the feature within the frame from static to moving; and
assigning all frame slices of the frame as refresh slices when the change in status is detected

31. The method of claim 20, wherein the step of quantizing comprises the step of:
modifying an amount of quantization based on available bandwidth for transmitting.

32. The method of claim 20, wherein the network packets comprise Ethernet packets.

33. The method of claim 20, wherein the step of transmitting comprises the steps of:
receiving network statistic information associated with transmission of the network packets; and
modifying a transmission rate of the network packets based on the received network statistic information.

34. A method of receiving multimedia information transmitted via a network, comprising the steps of:
extracting compressed multimedia information from network packets received via the network;
inverse variable length coding the extracted compressed multimedia information to generate quantized frequency domain components of frame slices of a frame of multimedia information;
inverse quantizing the quantized frequency domain components of the frame slices to generate frequency domain components of the frame slices;
inverse transforming the frequency domain components of the frames slices to generate a plurality of frame slices;
combining the plurality of frame slices to form the frame of multimedia information;
converting the frame from a first color space to a second color space,
wherein each component of the second color space is formed as a weighted combination of components of the first color space; and
displaying the converted frame on a display device.

35. The method of claim 34, wherein the step of combining comprises the step of:
replacing missing frame slices of the plurality of frame slices using corresponding frame slices from a previous frame.

36. The method of claim 34, wherein frequency domain components of the frame slices are inverse transformed into the plurality of frame slices using an inverse discrete cosine transform.

37. The method of claim 34, wherein the first color space comprises a luminance and chrominance (YUV) color space, and
wherein the second color space comprises a red, green, blue (RGB) color space.

38. The method of claim 34, comprising the step of:
adding porches surrounding an active portion of the frame.
